(19) United States
(12) Patent Application Publication
(10) Pub. No.: US 2013/0144585 A1
(43) Pub. Date: Jun. 6, 2013

(54) APPARATUS AND METHOD FOR IDENDIFICATON OF PROTEIN MODIFICATION

(71) Applicant: KOREA ADVANCED INSTITUTE OF SCIENCE AND TECHNOLOGY, Daejeon (KR)

(72) Inventors: Gwan-Su Yi, Daejeon (KR); Chiyong Kang, Daejeon (KR); Youngwoong Han, Daejeon (KR)

(73) Assignee: KOREA ADVANCED INSTITUTE OF SCIENCE AND TECHNOLOGY, Daejeon (KR)

(21) Appl. No.: 13/691,995

(22) Filed: Dec. 3, 2012

(30) Foreign Application Priority Data
Dec. 6, 2011 (KR) 10-2011-0129790
Oct. 5, 2012 (KR) 10-2012-0110597

(51) Int. Cl. G06F 19/12

(52) U.S. Cl. CPC G06F 19/12
USPC 703/11

(57) ABSTRACT

Provided is an apparatus for identification of a protein modification which identifies the protein modification, including: a fragment ion mass pattern producing unit for cutting a peptide modifier sequence with a virtual enzyme and producing a fragment ion mass pattern including mass information of the virtual fragment ions, a protein modification database for storing protein modification information including a kind and mass of protein modification, and a mass shift identifying unit for extracting a plurality of mass shift classes including fragment ions similar to each other in mass shift based on a mass shift of fragment ions extracted from a protein to be analyzed, combining the plurality of mass shift classes to produce a plurality of mass shift class sets, and identifying at least one protein modification included in at least one of the plurality of mass shift class sets based on the fragment ion mass pattern and the protein modification information.

### CROSS-REFERENCE TO RELATED APPLICATION

This application claims priority to and the benefit of Korean Patent Application Nos. 10-2011-0129790 and 10-2012-0110597 filed in the Korean Intellectual Property Office on Dec. 6, 2011, and Oct. 5, 2012, the entire contents of which are incorporated herein by reference.

### BACKGROUND OF THE INVENTION

(a) Field of the Invention

The present invention relates to an apparatus and method for identification of protein modification. (b) Description of the Related Art

Protein modification collectively refers to the occurrence of change after a protein is produced from genes through transcription and translation, and representative examples thereof include phosphorylation, acetylation, ubiquitination and the like. It has been revealed that protein modification plays an important role in the intracellular signaling pathway, and that particularly the peptide modifier plays an important role in the disease-related signaling pathway such as apoptosis and the like.

Recently, it has been revealed that ubiquitin (Ub) and ubiquitin-like proteins (Ubls) are deeply involved in disease-related apoptosis, signaling mechanism and the like, and thus these peptide modifiers are expected to have the possibility as being a biomarker. In order to measure protein modification, mass spectra data are measured and analyzed, and there emerges a need for technology that comprehensively analyzes a large amount of mass analysis information to measure various protein modifications. Various attempts have been made to quickly and efficiently identify protein modification without restriction on the kind thereof, but in consideration of the complex fragment ion mass of peptide modifier, there is a need for a better and efficient unrestricted post-translational modification (PTM) identification method.

Identification technologies of post-translational modification from tandem mass spectrometry (MS/MS) data have been continuously developed as the importance of PTM is emphasized. The first developed technology is a PTM identification technique that calculates all possible theoretical mass shifts to be matched with an actually measured mass value by considering only small number of restricted protein modifications. This method may reduce computational complexity of PTM identification. However, this method cannot consider various protein modifications altogether, and as a result, when there is an unexpected protein modification, there is danger that not only identifying PTMs but also the accuracy of identifying proteins may be decreased.

The restricted PTM identification technique is usually used in database-based programs that match a common protein sequence database to identify protein. MASCOT, SEQUEST, X!Tandem and the like are representative database-based protein identification programs that support the identification of PTM.

As another method, there is a PTM identification technique that utilizes a de novo protein sequence identification technique. Through this method, the sequence of protein may be inferred from only a protein mass analysis result without reference to the protein sequence database, and even the identification of the PTM may be attempted without restriction. However, this technique is disadvantageous in that when the computational complexity is high and protein sequence identification is not correctly performed, even PTM may not be correctly identified. Algorithms which attempt the sequence alignment of the sequence tag found through the de novo protein sequence identification with a candidate protein sequence, or use the result of the de novo protein sequence identification to perform an alignment comparison based on the mass values, thereby identifying PTM, have been published.

As the most recent method, there is a PTM identification technique that compares a theoretical protein fragment mass inferred from the sequence of a candidate protein with an actually measured protein fragment mass. This method can support an unrestricted PTM identification. The P-mod is a PTM identification algorithm of a mode that uses a precursor ion mass to calculate the amount of mass shift and applies a PTM that matches with the mass to an appropriate location. The biggest characteristic of P-mod is to use a p-value when the location of PTM is identified in this manner. P-mod may not detect the PTM without a precursor ion mass, and is disadvantageous in that when a plurality of PTMs is present, the performance thereof sharply deteriorates. Similarly to P-mod, PTM-Explorer identifies PTMs based on an already known sequence with the precursor ion mass information. The program is utilized to re-analyze a part of the protein mass analysis database in the related art, and as a result, PTMs which have not been known in the related art are found to re-confirm the usefulness of re-analyzing the protein mass analysis database. This mode is limited in the mass range of PTM.

Finally, PTM identification techniques that are specific to the peptide modifier have been recently published. The peptide modifier of ubiquitin, ubiquitin-like proteins and the like produces a complex fragment ion mass pattern in combination with other PTMs when the proteins are fragmented for the protein mass analysis. The complex fragment ion mass pattern makes it difficult to perform a PTM identification, thereby causing an effect of decreasing the accuracy thereof. Further, general PTM identification algorithms in the related art do not consider the fragment ion mass pattern, and thus the number of clues used to capture the peptide modifier is significantly decreased. SUMmOn is an algorithm that considers the fragment ion mass pattern of the peptide modifier, but is disadvantageous in that only SUMmOn may not consider a general PTM together. In addition, the algorithms that identify the peptide modifier in the related art may not perform identification without a precursor ion mass, and only one fragment ion mass per 100 Dalton (Da) unit is preferentially considered, and thus there is limitation on a precise analysis.

As described above, PTM analysis algorithms in the related art each have various limitations, and among them, most of the algorithms may not identify the peptide modifier. Furthermore, the algorithm that is specific to the peptide modifier identification may not consider other PTMs simultaneously, and has limitations such as an inability to identify mass analysis data without a precursor ion mass, and the like.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and method for identification of a peptide modifier without restriction on the kind of protein modification included in the mass analysis data in consideration of a fragment ion mass pattern produced from a peptide modifier.

An exemplary embodiment of the present invention provides an apparatus for identification of a protein modification which identifies the protein modification, including: a fragment ion mass pattern producing unit for cutting a peptide modifier sequence with a virtual enzyme to produce virtual fragment ions and producing a fragment ion mass pattern including a mass information of the virtual fragment ions; a protein modification database for storing a protein modification information including a kind and mass of protein modification; and a mass shift identifying unit for extracting a plurality of mass shift classes including fragment ions similar to each other in mass shift based on a mass shift of fragment ions extracted from a protein to be analyzed, combining the plurality of mass shift classes to produce a plurality of mass shift class sets, and identifying at least one protein modification included in at least one of the plurality of mass shift class sets based on the fragment ion mass pattern and the protein modification information.

The fragment ion mass pattern producing unit may include a virtual enzyme processing unit for cutting the peptide modifier sequence with the virtual enzyme, a virtual fragment ion producing unit for producing virtual fragment ions capable of being produced from a protein modification sequence based on a sequence cut in the virtual enzyme processing unit, and a fragment ion mass calculating unit for calculating a mass of the virtual fragment ions to produce a fragment ion mass pattern including mass information of the virtual fragment ions.

The fragment ion mass pattern may include b-ion masses of protein modification measured as a protein modification, and mass shifts produced by y-ion masses of protein modification.

The mass shift identifying unit may identify a protein modification including a chemical protein modification and a peptide modifier.

Another exemplary embodiment of the present invention provides an apparatus for identification of a protein modification which identifies the protein modification, including: a mass shift class extracting unit for calculating a mass shift of an actually measured fragment ion mass and a virtual fragment ion mass based on mass analysis information and peptide sequence information of a protein to be analyzed and grouping fragment ions similar to each other in mass shift to produce a plurality of mass shift classes; a mass shift class combining unit for combining the plurality of mass shift classes to produce a plurality of mass shift class sets and calculating a mass shift difference between classes in each mass shift class set; and an identifying unit for using identification information of the protein modification to identify at least one protein modification corresponding to a mass shift difference between classes, in which the identification information of the protein modification includes a fragment ion mass pattern including mass information of virtual fragment ions produced from peptide modifier, and protein modification information including kinds and masses of various protein modifications.

The mass shift class extracting unit may calculate the actually measured fragment ion mass which is measured actually based on the mass analysis information, and the virtual fragment ion mass which is calculated theoretically from the peptide sequence information.

The identifying unit may select at least one candidate mass shift class set which has a mass shift difference between classes similar to each other in the identification information of the protein modification among a plurality of mass shift class sets.

The identifying unit may identify protein modification information of each candidate mass shift class set based on the mass shift difference between classes of each candidate mass shift class set.

The apparatus for identification of a protein modification further includes an outputting unit for selecting a final mass shift class set similar in the mass analysis information of the protein to be analyzed from at least one candidate mass shift class set, and outputting at least one protein modification corresponding to the final mass shift class set.

Yet another exemplary embodiment of the present invention provides a method for identifying a protein modification by an apparatus for identification of protein modification, including: calculating a mass shift of fragment ions constituting a protein to be analyzed based on mass analysis information and peptide sequence information of the protein to be analyzed; grouping fragment ions showing a mass shift within a predetermined range to extract a plurality of mass shift classes; combining the plurality of mass shift classes to produce a plurality of mass shift class sets; and using identification information of the protein modification to identify at least one protein modification included in at least one mass shift class set, in which the identification information of the protein modification includes a fragment ion mass pattern including mass information of virtual fragment ions produced from a peptide modifier, and protein modification information including kinds and masses of various protein modifications.

The identifying of the at least one protein modification may identify at least one protein modification of a chemical protein modification and a peptide modifier.

The identifying of the at least one protein modification may calculate a mass shift difference between classes in each mass shift class set and identify at least one protein modification corresponding to a mass shift difference between classes based on the identification information of the protein modification.

Still another exemplary embodiment of the present invention provides a method for identifying a protein modification by an apparatus for identification of a protein modification, including: calculating a mass shift of an actually measured fragment ion mass and a virtual fragment ion mass based on mass analysis information and peptide sequence information of a protein to be analyzed; grouping fragment ions similar to each other in mass shift to extract a plurality of mass shift classes and combining the plurality of mass shift classes to produce a plurality of mass shift class sets; calculating a mass shift difference between classes in each mass shift class set; and identifying at least one protein modification corresponding to a mass shift difference between classes based on identification information of the protein modification, in which the identification information of the protein modification may include a fragment ion mass pattern including mass information of virtual fragment ions produced from a peptide modifier, and protein modification information including kinds and masses of various protein modifications.

The identifying of the at least one protein modification may include selecting at least one candidate mass shift class set having a mass shift difference between classes similar to each other in the identification information of the protein modification among the plurality of mass shift class sets, identifying protein modification information of each candidate mass shift class set based on a mass shift difference between classes of each candidate mass shift class set, and selecting a final mass shift class set similar in mass analysis information of the protein to be analyzed among at least one candidate mass shift class set, and outputting at least one protein modification corresponding to the final mass shift class set.

According to exemplary embodiments of the present invention, a fragment ion mass pattern of a peptide modifier, which protein modification identification programs in the related art fail to consider, is considered to identify the protein modification, and thus a correct protein modification may be identified. According to exemplary embodiments of the present invention, various peptide modifiers may be identified. According to exemplary embodiments of the present invention, a peptide modifier such as ubiquitin, ubiquitin-like proteins and the like may be simultaneously and efficiently identified together with a chemical protein modification such as phosphorylation or acetylation. Further, according to exemplary embodiments of the present invention, a large amount of mass analysis data may be analyzed under a distributed computing environment to identify a protein at which a specific protein modification occurs and a location of the modification.

### BRIEF DESCRIPTION OF THE DRAWINGS

FIG. 1 is a block diagram of an apparatus for identification of protein modification according to an exemplary embodiment of the present invention.

FIG. 2 is a block diagram of a fragment ion mass pattern producing unit according to an exemplary embodiment of the present invention, and FIGS. 3 and 4 are views describing mass shifts according to an exemplary embodiment of the present invention. FIG. 5 is a block diagram of a mass shift identifying unit according to an exemplary embodiment of the present invention.

FIG. 6 is a flowchart of a method for identification of protein modification according to an exemplary embodiment of the present invention.

FIG. 7 is a flowchart of a method for producing a fragment ion mass pattern according to an exemplary embodiment of the present invention.

FIG. 8 is a flowchart of a method for combining a mass shift class according to an exemplary embodiment of the present invention,

FIG. 9 is a view schematically describing a mass shift class according to an exemplary embodiment of the present invention, and

FIG. 10 is a view schematically describing a mass class set according to an exemplary embodiment of the present invention.

FIG. 11 is a flowchart of a method for identification of protein according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements.

An apparatus and method for identification of protein modification according to exemplary embodiments of the present invention will be described with reference to the drawings.

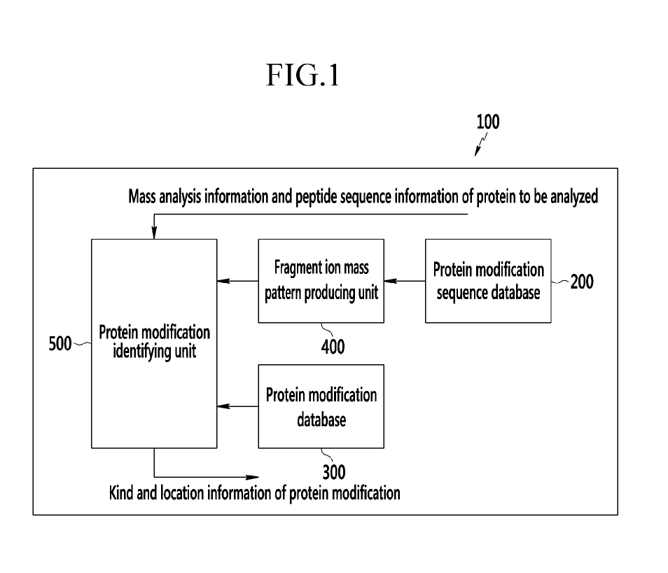

FIG. 1 is a block diagram of an apparatus for identification of protein modification according to an exemplary embodiment of the present invention.

Referring to FIG. 1, an apparatus for identification of protein modification 100 identifies the kind of post-translational modification (PTM) based on mass analysis information and peptide sequence information of a protein to be analyzed. For this purpose, the apparatus for identification of protein modification 100 includes a protein modification sequence database 200, a protein modification database 300, a fragment ion mass pattern producing unit 400 and a protein modification identifying unit 500. The apparatus for identification of protein modification 100 may operate based on distributed computing.

The protein modification sequence database 200 stores sequences of various protein modifications including peptide modifiers.

The protein modification database 300 stores information of various protein modifications. For example, the information of protein modifications includes the name of protein modification, the kind of protein modification, the kind of amino acid in which protein modification may be present, and the mass of protein modification.

The fragment ion mass pattern producing unit 400 cuts the sequence of peptide modifier stored in the protein modification sequence database 200 with a virtual enzyme to produce a virtual fragment ion. The fragment ion mass pattern producing unit 400 produces a fragment ion mass pattern based on the mass of virtual fragment ions. The fragment ion mass pattern is provided to the protein modification identifying unit 500 to become an important clue in identifying peptide modifier.

The protein modification identifying unit 500 is inputted with mass analysis information and peptide sequence information of a protein to be analyzed. The protein modification identifying unit 500 calculates an actually measured fragment ion mass which is actually measured based on the mass analysis information, and calculates a virtual fragment ion mass which is theoretically calculated from the peptide sequence information. The protein modification identifying unit 500 extracts a mass shift class based on a difference between the actually measured fragment ion mass and the virtual fragment ion mass. The difference between the actually measured fragment ion mass and the virtual fragment ion mass is a mass shift.

The protein modification identifying unit 500 combines the mass shift class to produce a mass shift class set. In one mass analysis information, no protein modification may be present and only one protein modification may be present, while two or more protein modifications may also be present at the same time. In addition, the peptide modifier produces a complex fragment ion mass pattern similarly to the presence of numerous protein modifications. Accordingly, the protein modification identifying unit 500 arbitrarily combines mass shift classes to produce a mass shift class set including various mass shift classes in order to consider various protein modifications simultaneously.

The protein modification identifying unit 500 identifies at least one protein modification corresponding to the mass shift in the mass shift class set based on the protein modification identification information. The protein modification identification information includes the fragment ion mass pattern and various kinds of protein modification information of the protein modification database 300.

Only the whole mass of the peptide modifier is written in the protein modification database 300. Accordingly, the protein modification identifying unit 500 may identify a chemical protein modification such as phosphorylation or acetylation having a simple chemical structure through the protein modification database 300. However, the protein modification identifying unit 500 may not grasp various mass shift classes produced from the split of the peptide modifier into fragment ions with only the protein modification database 300. Accordingly, the protein modification identifying unit 500 may use the fragment ion mass pattern which is the information for identifying a peptide modifier such as ubiquitin, ubiquitin-like proteins and the like and the protein modification database 300 to identify the chemical protein modification and the peptide modifier.

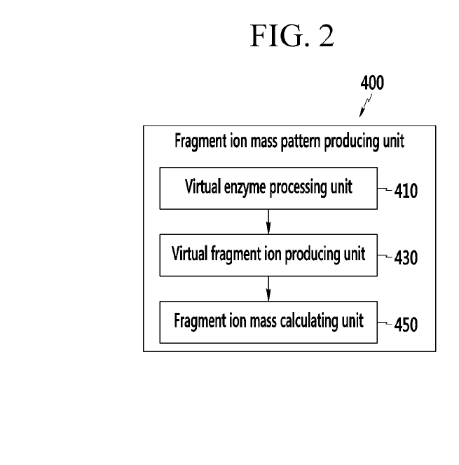

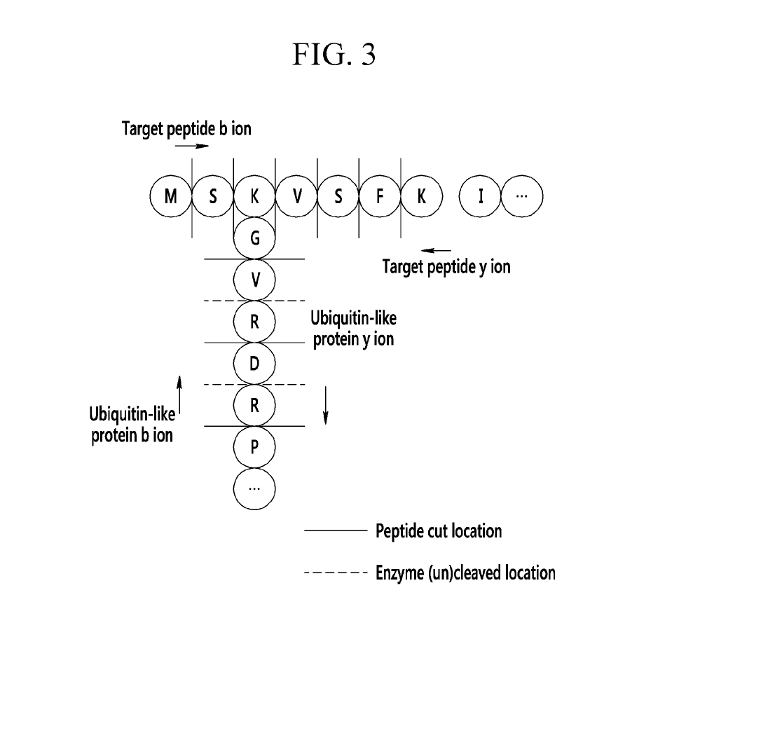

FIG. 2 is a block diagram of a fragment ion mass pattern producing unit according to an exemplary embodiment of the present invention, and FIGS. 3 and 4 are views describing mass shifts according to an exemplary embodiment of the present invention.

Referring to FIG. 2, the fragment ion mass pattern producing unit 400 includes a virtual enzyme processing unit 400, a virtual fragment ion producing unit 430 and a fragment ion mass calculating unit 450.

The virtual enzyme processing unit 400 cuts the peptide modifier sequence stored in the protein modification sequence database 200 with a virtual enzyme. The virtual enzyme processing unit 410 produces a short sequence. For example, the virtual enzyme processing unit 410 uses proteolysis laws of representative proteolytic enzymes such as trypsin to cut a peptide modifier sequence. Trypsin recognizes arginine and lysine among amino acids and cleaves arginine and lysine, and thus cuts the locations of arginine and lysine in the protein sequence. At this time, the location is not always cleaved even though there is arginine or lysine, and thus the virtual enzyme processing unit 410 may perform processing by considering even the case in which no cleavage occurs.

The virtual fragment ion producing unit 430 produces virtual fragment ions based on the cut sequence. When the fragment ion is produced, the protein modification sequence may be all fragmented at each amino acid location regardless of a specific amino acid, and thus the virtual fragment ion producing unit 430 performs processing by considering this point.

The fragment ion mass calculating unit 450 calculates the mass of the virtual fragment ion. That is, the fragment ion mass calculating unit 450 calculates the mass according to the kind of fragment ion and the sequence of an amino acid constituting the fragment ion. The fragment ion mass calculating unit 450 produces a fragment ion mass pattern including the mass information of each virtual fragment ion.

Referring to FIG. 3, a description will be provided by exemplifying the case in which a ubiquitin-like protein (Ubl), which is one of the peptide modifiers of the . . . PRDRVG sequence, is attached to the first K location of a protein whose sequence is MSKVSFK . . . .

When the mass of the ubiquitin-like protein b-ion is measured by a mass spectrometer, the mass of each ion is independently measured. For example, the ion mass until the . . . P, the ion mass until the . . . PR, the ion mass until the . . . PRD, and the like are measured.

When the mass of the ubiquitin-like protein y-ion is measured by a mass spectrometer, the ion mass of the existing protein is variously shifted.

Referring to FIG. 4, a mass shift does not occur to the ion mass until the M and MS, but each of various ubiquitin-like protein y-ions such as G, VG, RVG . . . and the like may be attached to all the K from the MSK. These various mass shifts occur to not only the MSK but also the MSKV, MSKVS and the like.

As described above, the fragment ion mass calculating unit 450 synthesizes the masses of virtual fragment ions which may be produced in the protein modification sequence to produce a fragment ion mass pattern. That is, the fragment ion mass calculating unit 450 produces a fragment ion mass pattern including ion masses of the b-ions of the protein modification, which is additionally measured as the protein modification and various mass shifts produced by the y-ions of the protein modification. Accordingly, the protein modification identifying unit 500 may identify a peptide modifier such as ubiquitin, ubiquitin-like proteins and the like through the fragment ion mass pattern.

FIG. 5 is a block diagram of a mass shift identifying unit according to an exemplary embodiment of the present invention.

Referring to FIG. 5, the protein modification identifying unit 500 includes a mass shift class extracting unit 510, a mass shift class combining unit 530, an identifying unit 550 and an outputting unit 570.

The mass shift class extracting unit 510 is inputted with mass analysis information and peptide sequence information of a protein to be analyzed. The mass shift class extracting unit 510 calculates an actually measured fragment ion mass which is actually measured based on the mass analysis information, and calculates a virtual fragment ion mass which is theoretically calculated from the peptide sequence information. The mass shift class extracting unit 510 uses an average amino acid mass or an amino acid mass of a single species isotope according to the form of the protein mass analysis information to perform the calculation. Furthermore, when the protein mass analysis information is produced, fragment ions which are different from each other in the kind thereof are produced according to characteristics of a machine that produces fragment ions, and thus the mass shift class extracting unit 510 calculates the virtual fragment ion mass by considering this point.

The mass shift class extracting unit 510 calculates a mass difference between the actually measured fragment ion mass and the virtual fragment ion mass, that is, a mass shift. At this time, the mass shift class extracting unit 510 may calculate all the mass differences between all the actually measured fragment ion masses and all the virtual fragment ion masses. The mass difference between the actually measured fragment ion mass and the virtual fragment ion mass may become a candidate for the mass shift caused by protein modification.

The mass shift class extracting unit 510 groups fragment ions similar to each other in mass difference to extract a mass shift class. The criteria of grouping fragment ions into a mass shift class are determined according to the resolution of a mass spectrometer. By producing the mass shift class, it is possible to grasp mass shift candidates caused by protein modification which would be difficult to measure with only each mass shift.

The mass shift class combining unit 530 arbitrarily combines a plurality of mass shift classes to produce a mass shift class set. The mass shift class combining unit 530 calculates a mass shift difference (hereinafter, referred to as “a mass shift difference between classes”) between mass shift classes in each mass shift class set. The mass shift class combining unit 530 calculates each mass difference while following mass shift classes included in one mass shift class set in the peptide sequence order. That is, the mass shift class combining unit 530 calculates a mass shift difference between classes in order to grasp whether the amount of the mass shift is an amount of mass shift caused by protein modification.

The identifying unit 550 identifies at least one protein modification based on a mass shift difference between classes in the individual mass shift class sets. At this time, the identifying unit 550 may preferentially use a mass shift class set that is high in ranking to identify a protein modification. This is because the amount of mass shift having high probability to be actually nonexistent is included in the mass shift class set by chance.

The identifying unit 550 uses the protein modification information of the protein modification database 300 and a fragment ion mass pattern of the peptide modifier to calculate the ranking of the mass shift class set. The identifying unit compares the mass shift difference between classes in the individual mass shift class sets with the protein modification information of the protein modification database 300, and compares the mass shift difference between classes in the individual mass shift class sets with the fragment ion mass pattern of the peptide modifier. The identifying unit 550 searches for the protein modification information of the protein modification database 300 and a mass shift difference between classes, which is similar to the fragment ion mass pattern of the peptide modifier. Moreover, the identifying unit 550 may search for a mass shift class set showing the mass shift difference between similar classes, and may impart a high ranking to the mass shift class set. The identifying unit 550 may calculate the ranking of the mass shift class set based on the number of fragment ions which coincides with a dispersion value of the amount of mass shift in the class.

The identifying unit 550 identifies the protein modification included in the mass shift class set based on the protein modification information stored in the protein modification database 300. At this time, the identifying unit 550 identifies a protein modification for a high ranking mass shift class set which is in a predetermined ranking or higher. The identifying unit 550 compares the mass shift difference between classes in the mass shift class set with the mass of protein modification stored in the protein modification database 300. When the mass shift difference between classes shows a difference with the mass of protein modification within a predetermined range, the identifying unit 550 maps the protein modification and the mass shift class set, which are used in the comparison, to be stored.

The identifying unit 550 collects each mass shift class set and the mapped protein modification information. The protein modification information includes the name of protein modification, the kind of protein modification, the kind of amino acid in which protein modification may be present, the mass of protein modification and the like.

As described above, the identifying unit 550 identifies the protein modification based on the mass shift difference between classes.

The outputting unit 570 selects a final mass shift class set similar to the mass analysis information of a protein to be analyzed. That is, the outputting unit 570 applies a protein modification identified from the mass shift class set to the sequence of the protein to be analyzed to compare the mass analysis information of the theoretical mass with that of the actually measured mass. Moreover, the outputting unit 570 selects a mass shift class set which is the most similar to the protein to be analyzed based on the mass comparison result.

One mass shift class set needs to perfectly describe a piece of mass analysis information. Accordingly, the accuracy of the mass shift class set may be finally checked depending on how correctly the fragment ion mass of the theoretically calculated mass shift class set coincides with the actually measured fragment ion mass.

The outputting unit 570 outputs the kind and location information of protein modification mapped in the final mass shift class set.

As described above, the apparatus for identification of protein modification 100 may produce a plurality of mass shift class sets, select a mass shift class set similar to the actually measured mass of the protein to be analyzed, and then output a protein modification identified from the similar mass shift class set.

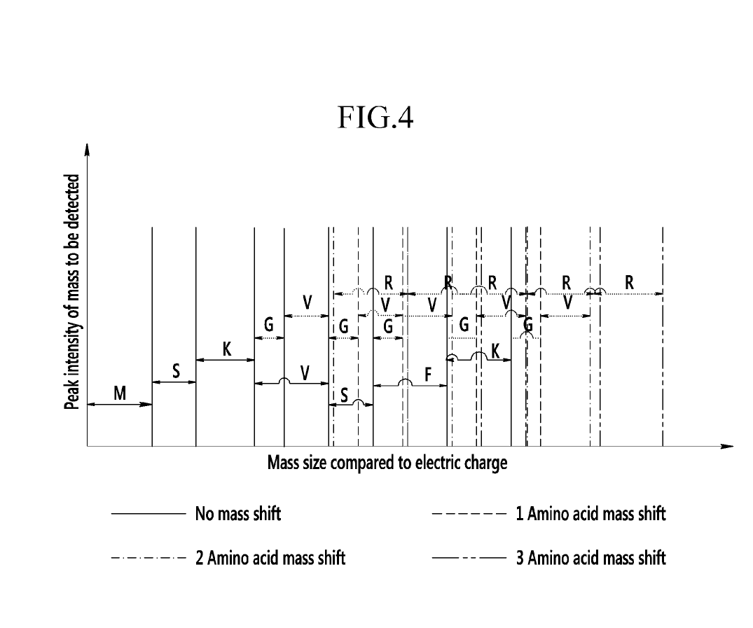

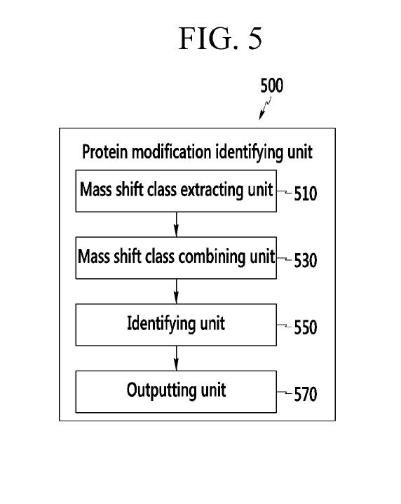

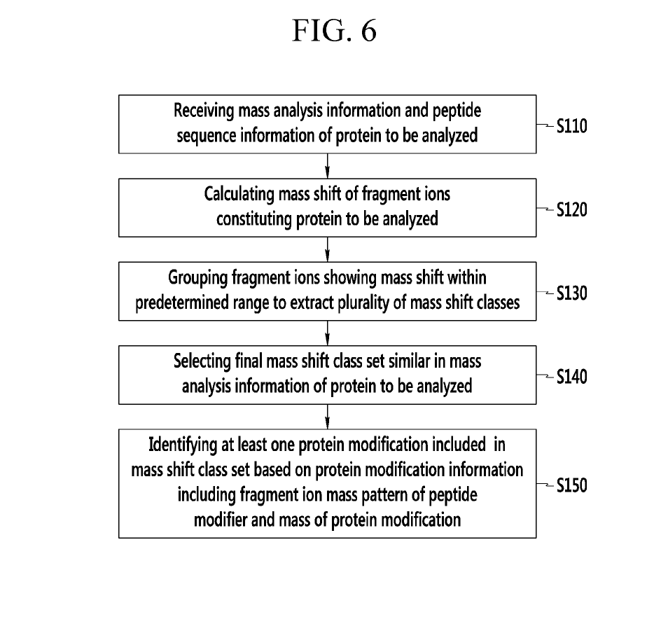

FIG. 6 is a flowchart of a method for identification of protein modification according to an exemplary embodiment of the present invention.

Referring to FIG. 6, the apparatus for identification of protein modification 100 is inputted with mass analysis information and peptide sequence information of the protein to be analyzed (S110).

The apparatus for identification of protein modification 100 calculates the mass shift of fragment ions constituting the protein to be analyzed (S120). That is, the apparatus for identification of protein modification 100 calculates a mass difference between an actually measured fragment ion mass which is actually measured based on the mass analysis information and a virtual fragment ion mass which is theoretically calculated from the peptide sequence information.

The apparatus for identification of protein modification 100 groups fragment ions showing a mass shift within a predetermined range to extract a plurality of mass shift classes (S130).

The apparatus for identification of protein modification 100 combines a plurality of mass shift classes to produce a plurality of mass shift class sets (S140).

The apparatus for identification of protein modification 100 identifies at least one protein modification included in the mass shift class set based on the protein modification information including a fragment ion mass pattern of a peptide modifier and a mass of protein modification (S150). Accordingly, the apparatus for identification of protein modification 100 may identify not only a chemical protein modification such as phosphorylation or acetylation, but also a complex peptide modifier such as ubiquitin, ubiquitin-like proteins and the like. Further, the apparatus for identification of protein modification 100 may identify not only one protein modification with one mass shift class, but also a plurality of protein modifications by combining a plurality of mass shift classes.

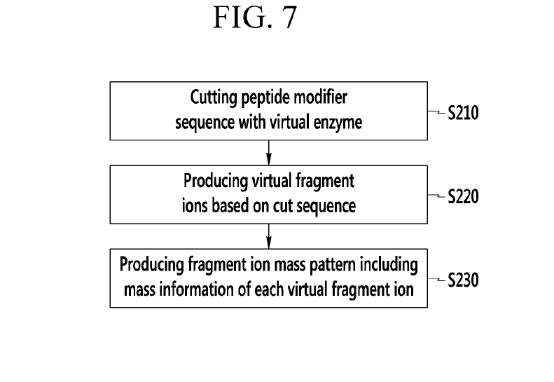

FIG. 7 is a flowchart of a method for producing a fragment ion mass pattern according to an exemplary embodiment of the present invention.

Referring to FIG. 7, the apparatus for identification of protein modification 100 identifies complex peptide modifiers such as ubiquitin-like proteins and the like based on the peptide-based fragment ion mass pattern.

The apparatus for identification of protein modification 100 cuts the peptide modifier sequence stored in the protein modification sequence database 200 with a virtual enzyme (S210).

The apparatus for identification of protein modification 100 produces virtual fragment ions based on the cut sequence (S220).

The apparatus for identification of protein modification 100 produces a fragment ion mass pattern including the mass information of each virtual fragment ion (S230). The fragment ion mass pattern includes b-ion masses of protein modification measured as the protein modification, and various mass shifts produced by a y-ion of protein modification. Accordingly, the apparatus for identification of protein modification 100 may identify various peptide modifiers such as ubiquitin, ubiquitin-like proteins and the like through the fragment ion mass pattern.

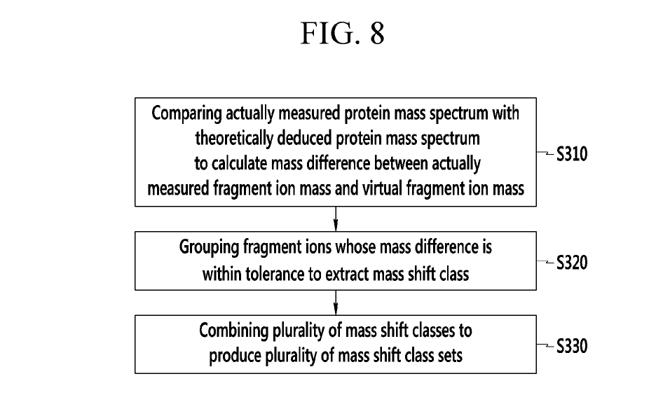

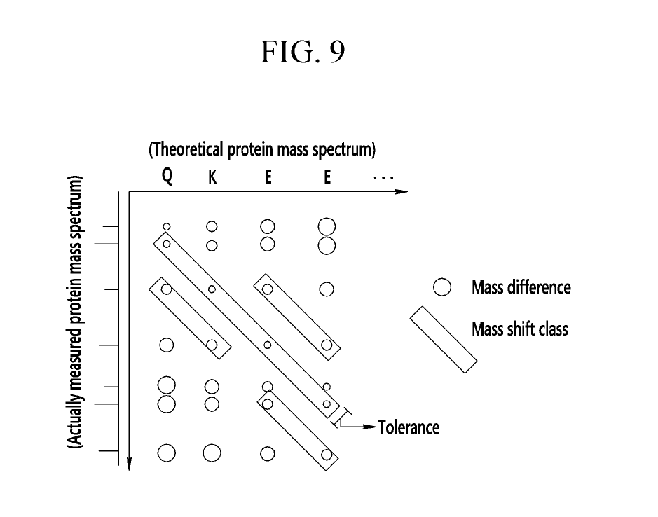

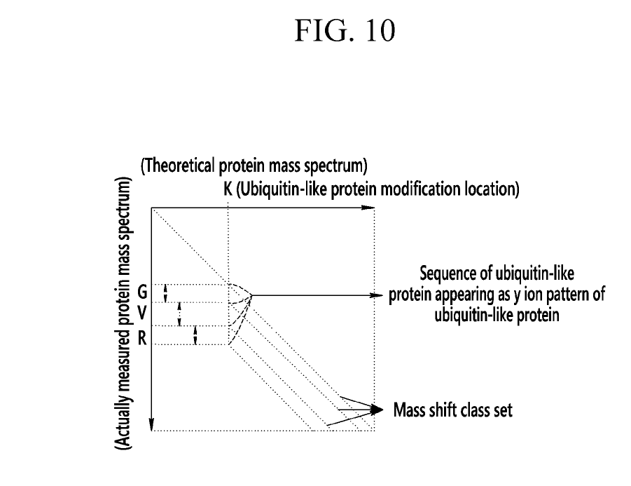

FIG. 8 is a flowchart of a method for combining a mass shift class according to an exemplary embodiment of the present invention, FIG. 9 is a view schematically describing a mass shift class according to an exemplary embodiment of the present invention, and FIG. 10 is a view schematically describing a mass shift class set according to an exemplary embodiment of the present invention.

Referring to FIGS. 8 and 9, the apparatus for identification of protein modification 100 compares an actually measured protein mass spectrum with a theoretically deduced protein mass spectrum to calculate a mass difference between the actually measured fragment ion mass and the virtual fragment ion mass (S310).

The apparatus for identification of protein modification 100 groups fragment ions whose mass difference is within a tolerance to extract a mass shift class (S320).

Referring to FIGS. 8 and 10, the apparatus for identification of protein modification 100 combines a plurality of mass shift classes to produce a plurality of mass shift class sets (S330).

As described above, the apparatus for identification of protein modification 100 arbitrarily combines a plurality of mass shift classes to produce a mass shift class set. Moreover, the apparatus for identification of protein modification 100 identifies mass shift differences between classes which are the same as the sequence of the peptide modifier in comparison with the fragment ion mass pattern of the peptide modifier to identify the peptide modifier.

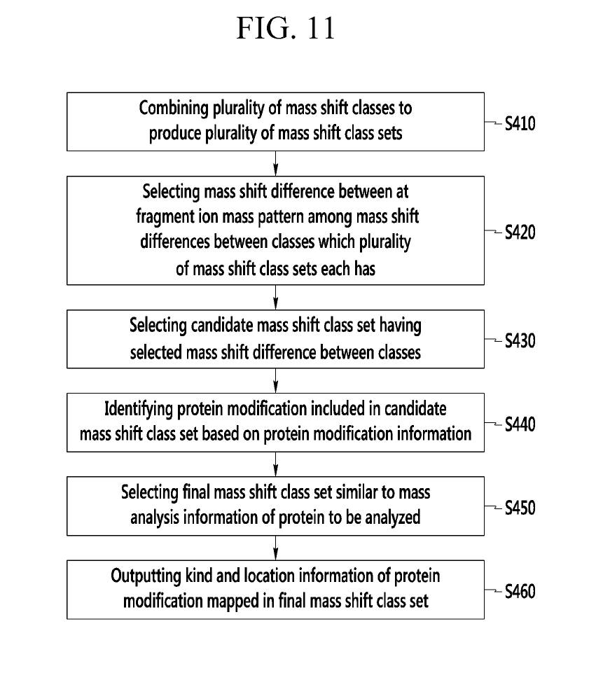

FIG. 11 is a flowchart of a method for identification of protein modification according to an exemplary embodiment of the present invention.

Referring to FIG. 11, the apparatus for identification of protein modification 100 combines a plurality of mass shift classes to produce a plurality of mass shift class sets (S410).

The apparatus for identification of protein modification 100 selects at least one mass shift difference between classes, which is similar to the protein modification information of the protein modification database 300 and the fragment ion mass pattern of peptide modifier among the mass shift differences between classes which a plurality of mass shift class sets each has (S420). The mass shift difference between classes in the individual mass shift class sets is compared with the protein modification information of the protein modification database 300, and the mass shift difference between classes in the individual mass shift class sets is compared with the fragment ion mass pattern of peptide modifier.

The apparatus for identification of protein modification 100 selects a mass shift class set having the selected mass shift difference between classes as a candidate mass shift class set (S430).

The apparatus for identification of protein modification 100 identifies a protein modification included in the candidate mass shift class set based on the protein modification information stored in the protein modification database 300 (S440). When the mass shift difference between classes shows a difference with the mass of protein modification within a predetermined range, the apparatus for identification of protein modification 100 maps the protein modification and the mass shift class set, which are used in the comparison, to be stored.

The apparatus for identification of protein modification 100 selects a final mass shift class set similar to the mass analysis information of the protein to be analyzed among candidate mass shift class sets Deleted Texts (S450).

The apparatus for identification of protein modification 100 outputs the kind and location information of the protein modification mapped in the final mass shift class set (S460).

According to exemplary embodiments of the present invention as described above, a fragment ion mass pattern of a peptide modifier, which protein modification identification programs in the related art fail to consider, may be considered to identify the protein modification, and thus a correct protein modification may be identified. According to exemplary embodiments of the present invention, various peptide modifiers may be identified. According to exemplary embodiments of the present invention, a peptide modifier such as ubiquitin, ubiquitin-like proteins and the like may be simultaneously and efficiently identified together with a chemical protein modification such as phosphorylation or acetylation. Further, according to exemplary embodiments of the present invention, a large amount of mass analysis data may be analyzed under a distributed computing environment to identify a protein at which a specific protein modification occurs and a location of the modification.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for identification of a protein modification which identifies the protein modification, comprising:
a fragment ion mass pattern producing unit for cutting a peptide modifier sequence with a virtual enzyme to produce virtual fragment ions and producing a fragment ion mass pattern comprising mass information of the virtual fragment ions;
a protein modification database for storing protein modification information comprising a kind and mass of protein modification; and
a mass shift identifying unit for extracting a plurality of mass shift classes comprising fragment ions similar to each other in mass shift based on a mass shift of fragment ions extracted from a protein to be analyzed, combining the plurality of mass shift classes to produce a plurality of mass shift class sets, and identifying at least one protein modification included in at least one of the plurality of mass shift class sets based on the fragment ion mass pattern and the protein modification information.

2. The apparatus for identification of a protein modification of claim 1, wherein:
the fragment ion mass pattern producing unit comprises
a virtual enzyme processing unit for cutting the peptide modifier sequence with the virtual enzyme,
a virtual fragment ion producing unit for producing virtual fragment ions capable of being produced from a protein modification sequence based on a sequence cut in the virtual enzyme processing unit, and
a fragment ion mass calculating unit for calculating masses of the virtual fragment ions to produce a fragment ion mass pattern comprising mass information of the virtual fragment ions.

3. The apparatus for identification of a protein modification of claim 1, wherein:
the fragment ion mass pattern comprises
b-ion masses of protein modification measured as a protein modification, and mass shifts produced by a y-ion masses of protein modification.

4. The apparatus for identification of a protein modification of claim 1, wherein:
the mass shift identifying unit
identifies a protein modification comprising a chemical protein modification and a peptide modifier.

5. An apparatus for identification of a protein modification which identifies the protein modification, comprising:
a mass shift class extracting unit for calculating a mass shift of an actually measured fragment ion mass and a virtual fragment ion mass based on mass analysis information and peptide sequence information of a protein to be analyzed and grouping fragment ions similar to each other in mass shift to produce a plurality of mass shift classes;
a mass shift class combining unit for combining the plurality of mass shift classes to produce a plurality of mass shift class sets and calculating a mass shift difference between classes in each mass shift class set; and
an identifying unit for using identification information of the protein modification to identify at least one protein modification corresponding to a mass shift difference between classes,
wherein the identification information of the protein modification comprises a fragment ion mass pattern comprising mass information of virtual fragment ions produced from a peptide modifier, and protein modification information comprising kinds and masses of various protein modifications.

6. The apparatus for identification of a protein modification of claim 5, wherein:
the mass shift class extracting unit
calculates the actually measured fragment ion mass which is measured actually based on the mass analysis information, and the virtual fragment ion mass which is calculated theoretically from the peptide sequence information.

7. The apparatus for identification of a protein modification of claim 5, wherein:
the identifying unit
selects at least one candidate mass shift class set which has a mass shift difference between classes similar to each other in the identification information of the protein modification among a plurality of mass shift class sets.

8. The apparatus for identification of a protein modification of claim 7, wherein:
the identifying unit
identifies protein modification information of each candidate mass shift class set based on the mass shift difference between classes of each candidate mass shift class set.

9. The apparatus for identification of a protein modification of claim 8, further comprising:
an outputting unit for selecting a final mass shift class set similar in the mass analysis information of the protein to be analyzed from at least one candidate mass shift class set, and outputting at least one protein modification corresponding to the final mass shift class set.

10. A method for identifying a protein modification by an apparatus for identification of a protein modification, the method comprising:
calculating a mass shift of fragment ions constituting a protein to be analyzed based on mass analysis information and peptide sequence information of the protein to be analyzed;
grouping fragment ions showing a mass shift within a predetermined range to extract a plurality of mass shift classes;
combining the plurality of mass shift classes to produce a plurality of mass shift class sets; and
using identification information of the protein modification to identify at least one protein modification included in at least one mass shift class set,
wherein the identification information of the protein modification comprises a fragment ion mass pattern comprising mass information of virtual fragment ions produced from a peptide modifier, and protein modification information comprising kinds and masses of various protein modifications.

11. The method of claim 10, wherein:
the identifying of at least one protein modification
identifies at least one protein modification of a chemical protein modification and a peptide modifier.

12. The method of claim 10, wherein:
the identifying of at least one protein modification
calculates a mass shift difference between classes in each mass shift class set and identifies at least one protein modification corresponding to a mass shift difference between classes based on the identification information of the protein modification.

13. A method of identifying a protein modification by an apparatus for identification of a protein modification, the method comprising:
calculating a mass shift of an actually measured fragment ion mass and a virtual fragment ion mass based on mass analysis information and peptide sequence information of a protein to be analyzed;
grouping fragment ions similar to each other in mass shift to extract a plurality of mass shift classes and combining the plurality of mass shift classes to produce a plurality of mass shift class sets;
calculating a mass shift difference between classes in each mass shift class set; and
identifying at least one protein modification corresponding to a mass shift difference between classes based on identification information of the protein modification,
wherein the identification information of the protein modification comprises a fragment ion mass pattern comprising mass information of virtual fragment ions produced from a peptide modifier, and protein modification information comprising kinds and masses of various protein modifications.

14. The method of claim 13, wherein:
the identifying of at least one protein modification comprises
selecting at least one candidate mass shift class set having a mass shift difference between classes similar to each other in the identification information of the protein modification among the plurality of mass shift class sets,
identifying protein modification information of each candidate mass shift class set based on a mass shift difference between classes of each candidate mass shift class set, and
selecting a final mass shift class set similar in mass analysis information of the protein to be analyzed among at least one candidate mass shift class set, and outputting at least one protein modification corresponding to the final mass shift class set.
